(19) United States
(12) Patent Application Publication
(10) Pub. No.: US 2008/0239291 A1
(43) Pub. Date: Oct. 2, 2008

(54) Inspection apparatus and inspection method

(75) Inventors: Yasuhiro Miyanohara, Hitachinaka (JP); Kenji Oka, Hitachinaka (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/078,096

(22) Filed: Mar. 27, 2008

(30) Foreign Application Priority Data
Mar. 30, 2007 (JP) 2007-091466

(51) Int. Cl. G01N 21/00; G01N 21/47

(52) U.S. Cl. 356/73; 356/446

(57) ABSTRACT

An elevating drive mechanism and an advancing drive mechanism are controlled, by means of control processing of the start of photomultiplier tube idling, such that the vertical irradiation position of a laser beam falls on a reflective plate and, during idling, laser beam is irradiated via reflective plate on photodetectors, which are photomultiplier tubes. When idling has come to an end and the inspection start of the following wafer occurs, a diagnosis of photomultiplier tubes is carried out. In case, as a result of the diagnosis, it is determined that photomultiplier tubes have degraded, an alarm is given that the photomultiplier tubes have degraded.

### BACKGROUND OF THE INVENTION

The present invention pertains to a surface inspection apparatus and inspection method to detect semiconductor surface contaminants, defects, and the like, occurring e.g. in semiconductor device manufacturing processes.

As an example of an inspection apparatus and an inspection method for an object under inspection, a wafer surface inspection method and inspection apparatus such as described in U.S. Pat. No. 5,903,342 or JP-A-1997-304289 can be cited.

In a wafer inspection apparatus, a laser beam output from a laser light source becomes a laser spot by means of a lens system, is projected perpendicularly or obliquely on a wafer surface and, in response to a movement of the wafer, the surface of the wafer is scanned spirally and, as a result thereof, the entire surface of the wafer is scanned.

If there is a contaminant on the surface of the wafer, diffuse light is generated at a wide-ranging angle (direction). A part thereof is condensed by means of a condenser lens and is received in a photomultiplier tube, which is a photoelectric converter. The light incident on the photomultiplier tube is here converted into electric signals and the converted electric signals (the received light signals) are data processed. As a result of the data processing, data indicating the number and size of the contaminants and the positions thereof are generated, and the state of the contaminants is mapped and displayed on a printer, a display, or the like.

A photomultiplier tube has the property that, in case there is no set current output, the output varies for a while thereafter. Because of this, in measurements after the apparatus has been halted for a long time, the sensitivity varies extending through a number of measurements after the start of the measurements. This tendency becomes more marked as the degradation of the photomultiplier tube advances.

Accordingly, by having the photomultiplier tube detect a fixed photoelectric current while on standby and holding it in an active state, it can be considered that sensitivity variations are prevented after a restart of the operation, but a reference light source must be installed in order to hold it in an active state, so there have been the problems that the mounting space becomes larger and the manufacturing cost is increased.

This becomes particularly marked in case a plurality of photomultiplier tubes are used.

### SUMMARY OF THE INVENTION

It is an object of the present invention to implement a stabilization of the sensitivity of the diffuse light detection unit associated with a surface inspection apparatus having photomultiplier tube (or the like) diffuse light detection units, and a surface inspection method.

The present invention is provided, in a surface inspection apparatus for an object under inspection, with a light irradiation unit irradiating illumination light on the object under inspection and is provided with a reflective plate reflecting the illumination light from this light irradiation unit, the illumination light from said irradiation light unit being irradiated on the aforementioned reflective plate during idling, at times other than during surface inspection of the object under inspection and the illumination light scattered by said reflective plate being irradiated on the aforementioned scattered light inspection unit.

Also, illumination light is irradiated on the surface of the object under inspection, the scattered illumination light is detected by means of a scattered light detection unit, and, in an inspection method for the object under inspection determining contaminants and the like on the surface of the aforementioned object under inspection, the aforementioned illumination light is irradiated on a reflective plate and the illumination light scattered by said reflective plate is irradiated on the aforementioned scattered light detection unit during idling, at times other than during surface inspection of the object under inspection, on the basis of the detected scattered light.

According to the present invention, it is possible to implement a stabilization of the scattered light detection unit sensitivity, in a surface inspection apparatus having a scattered light detection unit such as a photomultiplier tube, and in a surface inspection method.

### BRIEF DESCRIPTION OF THE DRAWINGS

FIG. 1 is a schematic structural plan view of a surface inspection apparatus to which Embodiment 1 of the present invention is applied.

FIG. 2 is a schematic front elevational view showing the internal structure of an inspection part of the surface inspection apparatus shown in FIG. 1.

FIG. 3 is a diagram showing the structure of a light irradiation part of the surface inspection apparatus shown in FIG. 1.

FIG. 4 is a diagram showing the relation between the locus of movement of a wafer under inspection and the irradiation direction of a laser beam.

FIG. 5 is a diagram of the internal structure of an inspection part during photomultiplier tube idling.

FIG. 6 is an operational flowchart during photomultiplier tube idling.

FIG. 7 is an operational flowchart during photomultiplier tube diagnosis.

FIG. 8 is a diagram showing an idling parameter settings screen.

FIG. 9 is a diagram showing a diagnostic parameter settings screen.

FIG. 10 is a diagram showing the screen of an alarm display.

FIG. 11 is a diagram showing the internal structure of an inspection part associated with Embodiment 2 of the present invention.

FIG. 12 is a diagram showing the internal structure of an inspection part associated with Embodiment 3 of the present invention.

FIG. 13 is an operational flowchart associated with Embodiment 3 of the present invention.

FIGS. 14A to 14C are explanatory diagrams of reflective mirrors used in the present invention.

### DETAILED DESCRIPTION OF THE INVENTION

### 1. First Embodiment

Hereinafter, an explanation will be given of the embodiments of the present invention, with reference to the accompanying drawings.

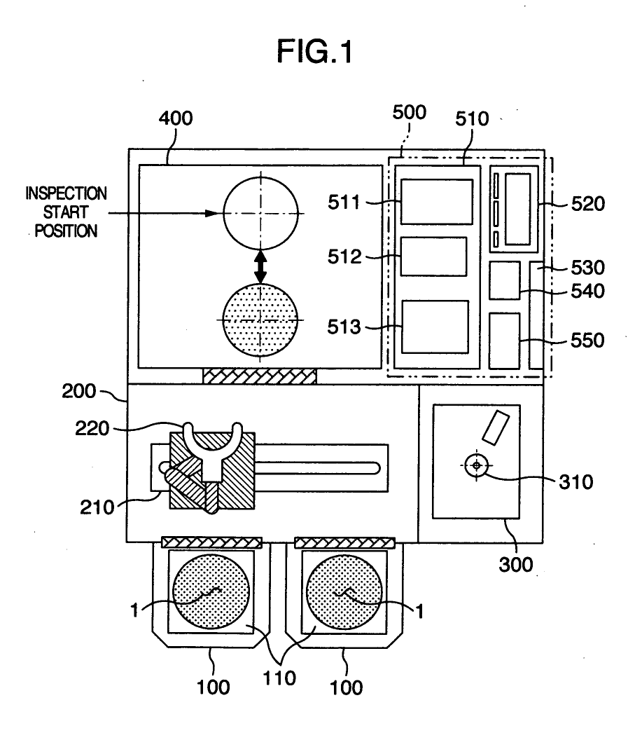

FIG. 1 is a schematic structural plan view of a surface inspection apparatus to which Embodiment 1 of the present invention is applied. In FIG. 1, the surface inspection apparatus is provided with one or several load ports 100 also having a placing and holding function for objects under inspection (wafers), a transport part 200, a prealignment part 300, an inspection part 400, and a data processing part 500.

In load port 100, there are placed and held one or several wafer pods 110 storing a plurality of wafers 1 for inspection and also having a storage function for objects under inspection. Wafers 1 of load port 100 are transported to inspection part 400 via prealignment part 300 by means of transport part 200. It is possible to choose all load ports 100 to be for pods for objects under inspection, but it is also possible to choose a part thereof to be for dedicated withdrawal pods 110 for wafers 1 determined to be defective in the inspection.

The aforementioned data processing part 500 is provided with a controller 510, an input device 520 consisting of a keyboard and a touch panel or a mouse, a visually displaying display device 530 consisting of a CRT (Cathode Ray Tube), a flat panel, or the like, an output device 540 such as a printer, and an external memory device 550 controlling external media.

Also, controller 510 is provided with a computational processing device 511, a memory device 512 such as an HDD (Hard Disk Drive), and a control device 513. This controller 510 carries out control of the entire contaminant inspection apparatus on the basis of instructions from input device 520, and displays information such as settings conditions, inspection results, and the operating state of the inspection apparatus on display device 530, and further outputs the concerned information to output device 540.

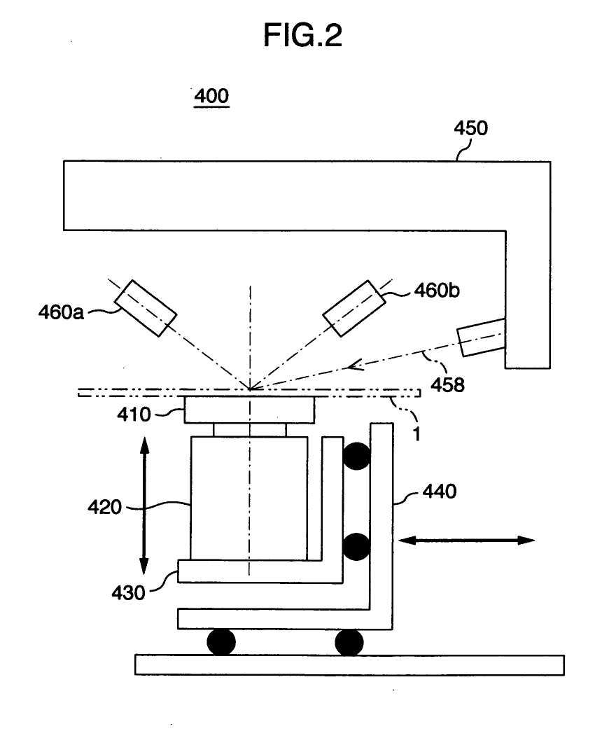

FIG. 2 is a longitudinal cross-sectional view showing the internal structure of the aforementioned inspection part 400. In FIG. 2, inspection part 400 is provided with a holding mechanism (holding unit) 410 having the function of holding wafer 1; a rotary drive mechanism 420 constituted by including a rotary device, such as a spindle motor (diagram omitted), rotating holding mechanism 410 and an angular position detection device (diagram omitted) consisting of an encoder or the like; an elevating drive mechanism 430 raising and lowering holding mechanism 410; and an advancing drive mechanism (linear drive mechanism) 440 moving approximately in parallel with the wafer 1 surface together with holding mechanism 410 and rotary drive mechanism 420 and elevating drive mechanism 430, and constituted by including a positional detection device (diagram omitted).

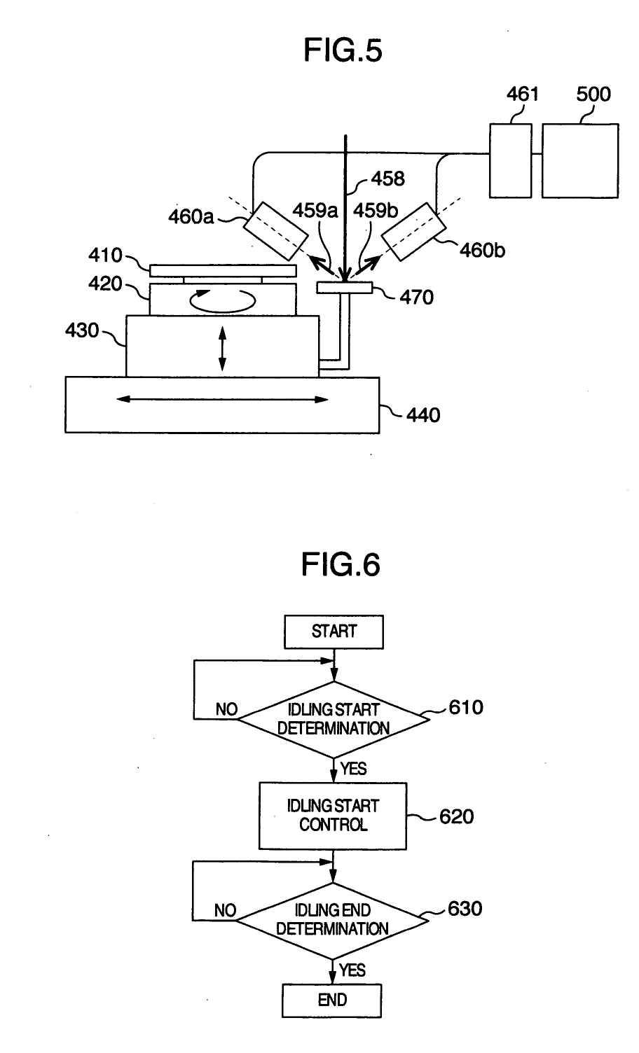

Inspection part 400 is provided with a light irradiation part (light irradiation unit) 450 irradiating a laser beam 458 (illumination light example) of e.g. visible laser light or ultraviolet laser light on the surface of wafer 1, and detectors 460a and 460b receiving scattered light from the surface of wafer 1. Although not shown in FIG. 2, inspection part 400 is provided with a reflective plate 470 (shown in FIG. 5) scattering and reflecting laser beam (illumination light) 458 during idling (scattered light emission means).

Detectors 460a and 460b are photomultiplier tubes that may either be single or a plurality of two or more, two units (460a and 460b) being arranged as an example in Embodiment 1 of the present invention.

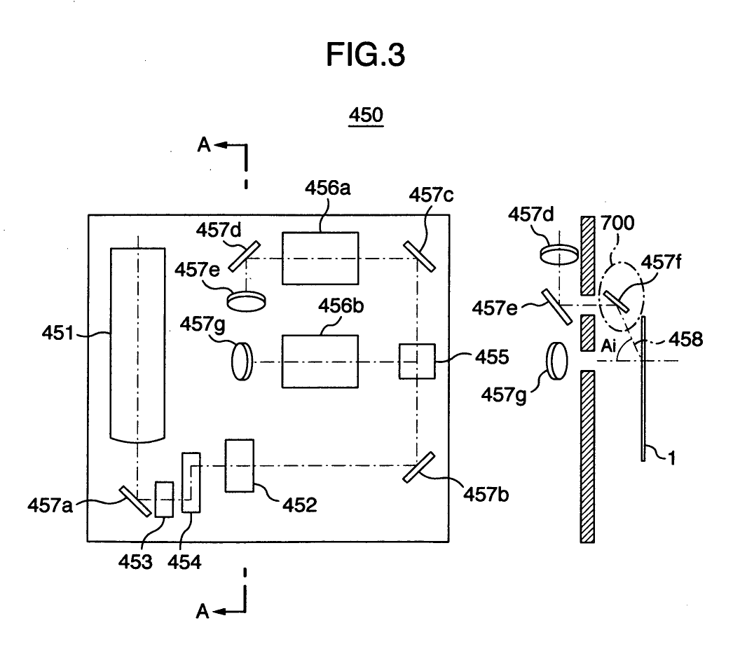

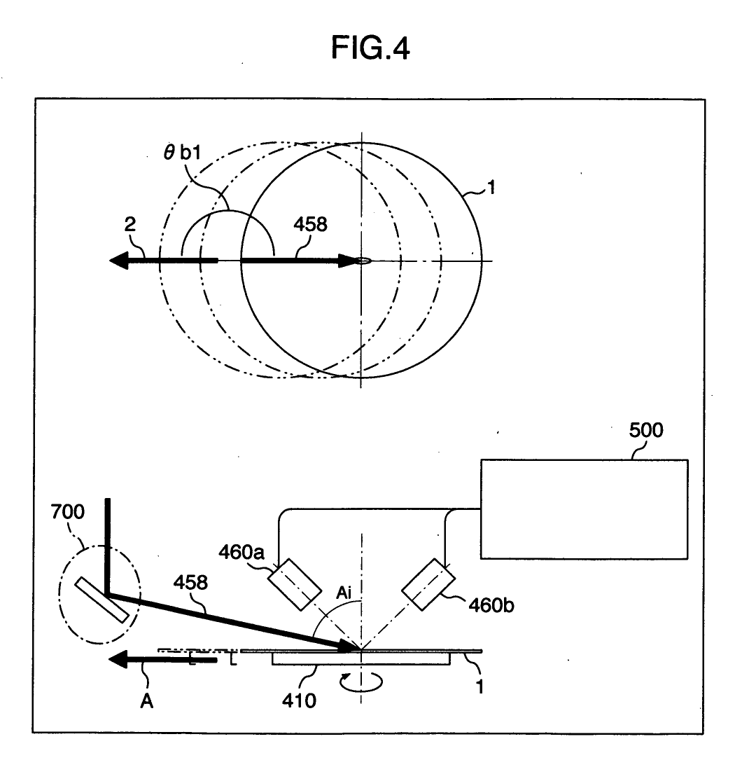

FIG. 3 is a diagram showing the schematic structure of light irradiation part 450, a schematic plane being shown on the left-hand side and a cross section taken along the A-A line of this schematic plane being shown on the right-hand side. Also, FIG. 4 is a diagram showing the relation between locus of movement 2 of wafer 1 during inspection and the irradiation direction of laser beam 458.

In FIG. 3, light irradiation part 450 is provided with a laser light source 451 generating laser beam 458, an attenuator 453 adjusting the strength of laser beam 458, an optical axis correction mechanism 454 correcting the optical axis misalignment of laser beam 458, a shutter 452 blocking laser beam 458, an irradiation direction switching mechanism 455 for switching the irradiation direction of laser beam 458 obliquely or perpendicularly, beam shaping mechanisms 456a and 456b shaping the cross-sectional form of laser beam 458 into the target form, and mirrors 457a to 457g changing the path direction of laser beam 458.

Laser beam 458 is emitted from laser light source 451, passes mirror 457a, and gets its energy density adjusted by attenuator 453 to one appropriate for the inspection. Next, it passes optical axis correction mechanism 454 correcting optical axis misalignment, mirror 457b, irradiation direction switching mechanism 455, and mirror 457c and gets its cross-sectional shape adjusted to the purpose of inspection in beam shaping mechanism 456a. And then, the path direction of laser beam 458 is changed consecutively through mirror 457d to mirror 457f and is irradiated on wafer 1.

Also, as shown in FIG. 4, laser beam 458 is controlled, by means of a light emission part 700 constituted by including mirror 457f and an irradiation angle control mechanism (diagram omitted), to have the desired irradiation angle Ai with respect to a normal line of the reference face of holding mechanism 410 or the smooth face of wafer 1, by adjusting the angle of mirror 457f in advance by human intervention or by controlling it automatically.

Laser beam 458 reflected in mirror 457b, and coming from irradiation direction switching mechanism 455 is shaped in beam shaping mechanism 456b into a cross-sectional form appropriate for the purpose of inspection, is reflected by means of mirror 457g and irradiated on wafer 1.

Next, an explanation will be given regarding the processing flow of the surface inspection apparatus associated with Embodiment 1 of the present invention. The inspection of wafer 1 is started by execution of an inspection program. With a handling arm 220 provided in a transport device 210 inside transport part 200 shown in FIG. 1, wafer 1 is extracted from wafer pod 110 and is transported from load port 100 to prealignment part 300.

And then, as for wafer 1 disposed in a placing and holding part 310 of prealignment part 300, there is carried out a rough position correction (prealignment) of a notch position with the approximate center position of wafer 1. Prealigned wafer 1 is once again extracted with handling arm 220, is transported to wafer holding mechanism 410 provided in inspection part 400 and is held on top of this wafer holding mechanism 410.

By means of an inspection start command from controller 510, elevating drive mechanism 430 and advancing drive mechanism 440 are controlled to carry out a correction of the starting point of the surface inspection so that laser beam 458 is irradiated on the approximate center, computed in advance, of wafer 1. On the occasion of this correction, rotary drive mechanism 420 starts beforehand the rotation of wafer holding mechanism 410, in parallel with the operation of the starting point position correction, and the rotation rate is increased to shorten the required time needed for the surface inspection. Controller 510 controls rotary drive mechanism 420 so that a fixed rotation rate is reached at the approximate completion time of the position correction and holds it at a prescribed rotation rate.

Wafer 1, held by holding mechanism 410, is rotated at high speed by means of rotary drive mechanism 420 and, as shown in FIG. 4, due to the fact that advancing drive mechanism 440 moves approximately in parallel (laser scanning direction) with the surface of wafer 1 while laser beam 458 is irradiated on the surface of wafer 1, laser beam 458 moves helicoidally, vortically, or circularly in relative terms, and there is a scan across the inspection surface at high speed.

By means of the irradiation by laser beam 458, the scattered light generated from a contaminant or a defect on wafer 1 is received by detectors 460a and 460b (scattered light detection units) and, together with relative movement positional information of advancing drive mechanism 440 and rotary drive mechanism 420, the data are analyzed in controller 510 and the size of the contaminant or the defect and the positional coordinates inside wafer 1 (surface detection unit) are obtained.

Wafer 1, for which the inspection has come to an end, is once again extracted by handling arm 220, transported from wafer holding mechanism 410 to load port 100, and is put in storage to wafer pod 110. Thereafter, the inspection apparatus carries out processing of the photomultiplier tube idling.

FIG. 5 is a diagram showing the relations during photomultiplier tube idling between wafer holding mechanism 410, rotary drive mechanism 420, and elevating drive mechanism 430, and advancing drive mechanism 440, detectors 460a and 460b, laser beam 458, and reflective plate 470. In FIG. 5, elevating drive mechanism 430 and advancing drive mechanism 440 are controlled (operating control unit) such that the vertical irradiation position of laser beam 458 falls on reflective plate 470. The scattered light emitted at this time from reflective plate 470 is detected in detectors 460a and 460b and after converting it by means of a light detection signal processor 461 into a signal (signal processing unit) which can be processed in data processing part 500 for A/D conversion and the like, the signal is processed by data processing part 500.

FIG. 6 is a diagram showing an operational flowchart during photomultiplier tube idling. In FIG. 6, processing step 610 of determining the start of photomultiplier tube idling determines the purpose of use (automatic inspection or maintenance) and the lapse time from the end of inspection operation and, when a prescribed time has elapsed, the process branches to processing step 620 of controlling the start of photomultiplier tube idling. It is e.g. possible, with automatic inspection, to start photomultiplier tube idling processing under the condition that at least a prescribed time has elapsed from the end of inspection of the previous wafer. “Prescribed time” means the time in which an influence on the variations in the characteristics of the photomultiplier tubes begins to appear, being e.g. on the order of 60 seconds.

And then, processing step 620 of controlling the start of photomultiplier tube idling sets the laser light quantity of laser light source 451 and the impressed voltage on detectors 460a and 460b to pre-registered values, switches irradiation direction switching mechanism 455 to a vertical direction, and controls elevating drive mechanism 430 and advancing drive mechanism 440 such that the vertical irradiation position of laser beam 458 falls on reflective plate 470.

Thereafter, shutter 452 is opened and the illumination by laser beam 458 starts. It is desirable for reflective plate 470 to be one having a surface shape emitting scattered light of laser beam 458 as uniformly as possible in the directions of detectors 460a and 460b. It is e.g. a surface which has a rough face obtained by using a treatment such as grinding, etching, or coating on a substrate surface which is flat (wafer) or has spheroids, and is composed of glass, ceramic, a semiconductor, or the like. Moreover, as for reflective plate 470, it is also possible to place a wafer for reflection, instead of the wafer for inspection, on top of wafer holding mechanism 410, or it can be disposed beside wafer holding mechanism 410.

Next, the process advances from processing step 620 to processing step 630 of determining the end of photomultiplier tube idling and when there has occurred a start of the inspection of the following wafer or a switching of the purpose of use, processing for photomultiplier tube idling is ended. A switch in the purpose of use means a transfer to the maintenance function and a halt of the apparatus.

When there has occurred an inspection start for the following wafer in processing step 630 of determining the end of photomultiplier tube idling, a diagnosis of the photomultiplier tube is carried out.

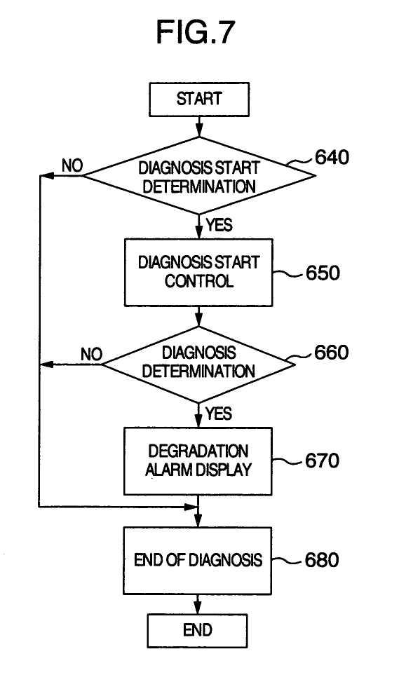

FIG. 7 is a diagram showing the operational flowchart during diagnosis of the photomultiplier tube. In FIG. 7, processing step 640 of determining the start of the photomultiplier tube diagnosis determines the main cause of ending processing step 630 of determining the end of photomultiplier tube idling and branches to processing step 650 of controlling the start of the photomultiplier tube diagnosis or processing step 680 of ending the photomultiplier tube diagnosis. In processing step 640, the process branches to processing step 650 of controlling the photomultiplier tube diagnosis start in case the time is e.g. situated before the inspection start of the following wafer, and to processing step 680 of ending the photomultiplier tube diagnosis in other cases.

In processing step 650 of controlling the start of the photomultiplier tube diagnosis, the laser light quantity of laser light source 451 and the impressed voltage of detectors 460a and 460b are set to pre-registered values for the photomultiplier tube diagnosis.

Next, the process advances to processing step 660 of determining the photomultiplier tube diagnosis, the detection signals of detectors 460a and 460b are processed by means of data processing part 500 and, in case the signals are equal to or less than a threshold value, it is determined that the photomultiplier tube has degraded and the process branches to processing step 670 of displaying a photomultiplier tube degradation alarm. In processing step 660, in case the threshold value is exceeded, it is determined that the photomultiplier tube has not degraded and the process branches to processing step 680 of ending the photomultiplier tube diagnosis.

In processing step 670 of displaying a photomultiplier tube degradation alarm, the result of the photomultiplier tube diagnosis is output to display device 530 and an alarm is given that a photomultiplier tube has degraded (degradation alarm unit).

Also, in processing step 680 of ending the photomultiplier tube diagnosis, shutter 452 is closed and the laser beam 458 illumination is halted. Thereafter, transport operation and movements due to advancing drive mechanism 440 and the like are carried out until laser beam 458 illumination is once again carried out due to the start of the inspection of wafer 1, but since it is for a short time, it may be considered that the photomultiplier tubes are not subject to sensitivity variations.

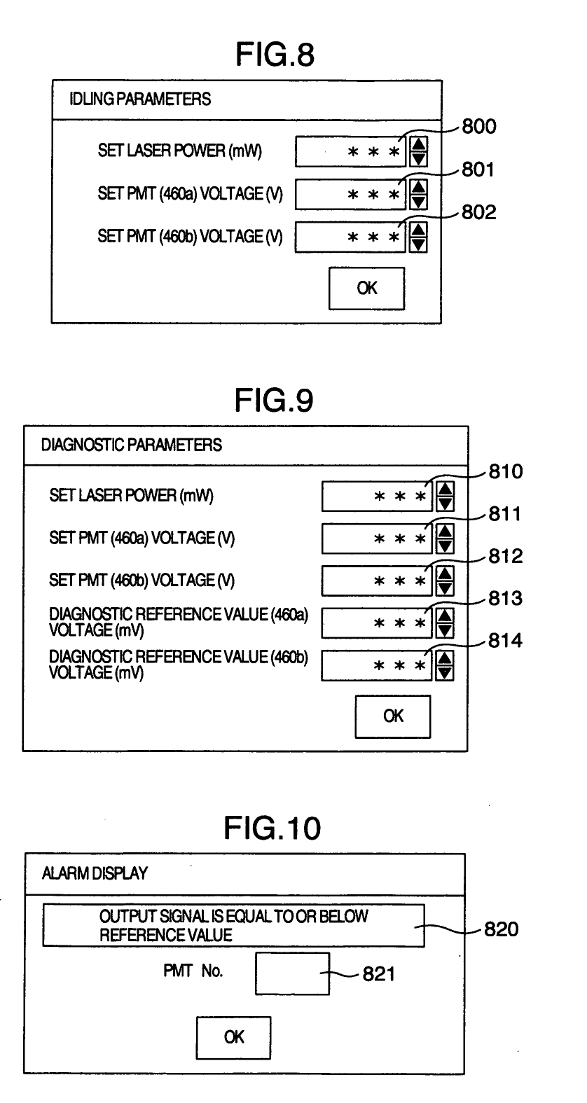

FIG. 8 is a diagram showing a settings screen displayed on display device 530 during idling of an inspection apparatus associated with Embodiment 1 of the present invention, which is the settings screen associated with processing step 620 shown in FIG. 6.

In FIG. 8, the screen is configured as a settings screen on display device 530, comprising an entry part 800, for output values of laser light source 451 used during photomultiplier tube idling, and entry parts 801 and 802, for the control voltages of photomultiplier tubes 460a and 460b used during idling of the photomultiplier tubes, the set values being changeable.

FIG. 9 is a diagram showing a settings screen during processing of the determination of a photomultiplier tube diagnosis associated with Embodiment 1 of the present invention, the settings screen associated with processing steps 650 and 660 shown in FIG. 7.

In FIG. 9, the screen is configured as a settings screen on display device 530, comprising an entry part 810, for output values of laser light source 451 used during judgment of the photomultiplier tube diagnosis, and entry parts 811 and 812, for the control voltages of photomultiplier tubes 460a and 460b, and entry parts 813 and 814, for the diagnostic reference values of photomultiplier tubes 460a and 460b, used during judgment of the diagnosis of the photomultiplier tubes, the set values being changeable.

FIG. 10 is a diagram showing a screen of the photomultiplier tube degradation alarm display associated with Embodiment 1 of the present invention. In FIG. 10, it is configured as a display screen on display device 530, comprising an alarm content display part 820 and a display part 821 corresponding to the photomultiplier tube being the object of the alarm.

Further, in Embodiment 1 of the present invention, these inputs and display parts are configured with spaces and buttons, but it is even possible to apply some other unit to the present invention that is capable of signal input and transmission and display. Also, it is acceptable to use icons and a keyboard or some other signal input transmission unit or display unit.

As mentioned above, it is possible, according to Embodiment 1 of the present invention to report the calibration time by means of degradation detection since detection of the degradation of a photomultiplier tube can be carried out automatically, so the necessity of periodically carrying out a calibration in a state where it is unclear whether there is degradation or not is avoided.

In other words, since a surface inspection apparatus in the prior art was not able to automatically carry out detection of degradation, there was the possibility, because periodic calibrations were implemented and sensitivity corrections were carried out, of generating a situation in which calibration was performed even if there was no degradation or no calibration was executed even if there was degradation.

Further, in Embodiment 1 of the present invention, it is also possible to automate calibrations. Also, since a measurement light source is used during this degradation detection, it is unnecessary to correct for differences in characteristics with the reference light source by computation or the like, so degradation detection can be carried out with high accuracy. Due to this fact, it is possible to improve the stability and reliability of the contaminant detection performance.

### 2. Second Embodiment

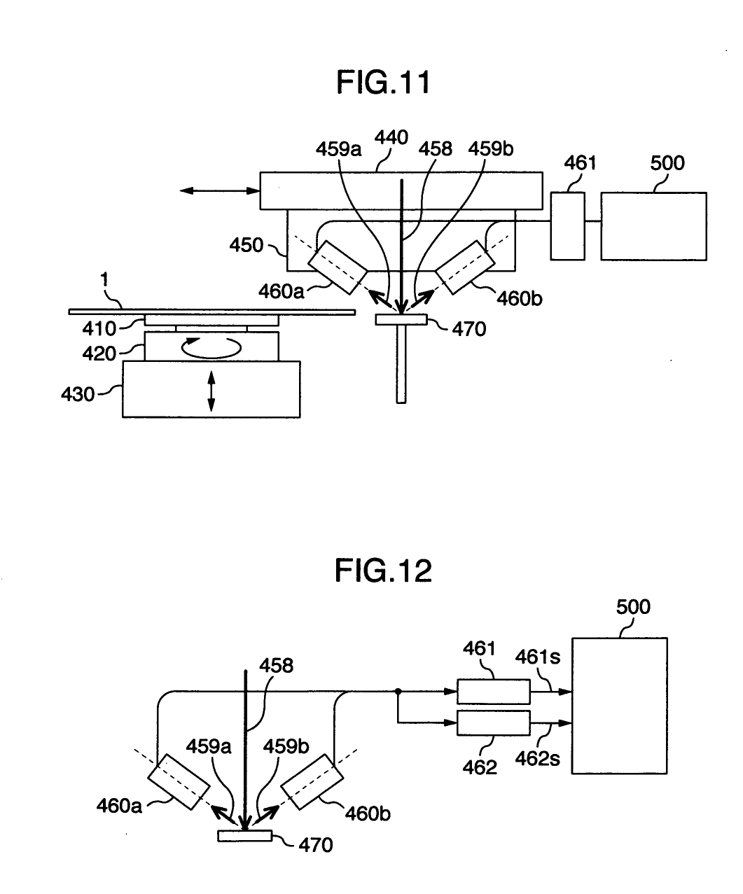

Next, an explanation of Embodiment 2 of the present invention will be given, with reference to FIG. 11.

The points which differ between this Embodiment 2 and Embodiment 1 are that advancing drive mechanism 440 is not used for the movement of wafer 1 but is used for the movement of light irradiation part 450 and detectors 460a and 460b and that a configuration has been chosen in which reflective plate 470 is separated from elevating drive mechanism 430. Since the rest of the configuration is the same as for Embodiment 1, a detailed explanation thereof will be omitted.

In FIG. 11, an inspection apparatus being Embodiment 2 is provided with a holding mechanism 410 having the function of holding wafer 1, a rotary drive mechanism 420 having a rotary device such as a spindle motor (diagram omitted) rotating holding mechanism 410 and an angular position detection device (diagram omitted) consisting of an encoder or the like, and an elevating drive mechanism 430 raising and lowering holding mechanism 410. Further, the inspection apparatus is provided with a light irradiation part 450 irradiating a laser beam 458 (illumination light example) of e.g. visible laser light or ultraviolet laser light on the surface of wafer 1 and a reflective plate 470, a reflective plate 470 reflecting laser beam (illumination light) 458 during idling, detectors 460a and 460b receiving scattered light from the surface of wafer 1 and scattered light from reflective plate 470, and an advancing drive mechanism (linear drive mechanism) 440 having a positional detection device (diagram omitted) moving light irradiation part 450 and detectors 460a and 460b approximately in parallel with the surface of wafer 1.

According to Embodiment 2 of the present invention, in addition to the fact that it is possible to obtain the same effect as with Embodiment 1, there is the effect that it becomes possible, even during the transport movement of wafer 1, to continue the idling operation of the photomultiplier tubes since the position of wafer 1 and the position of reflective plate 470 are separated. In other words, it is possible to shorten the time during which laser beam 458 is not incident on the photomultiplier tubes, so the stability of the photomultiplier tubes can be improved.

### 3. Third Embodiment

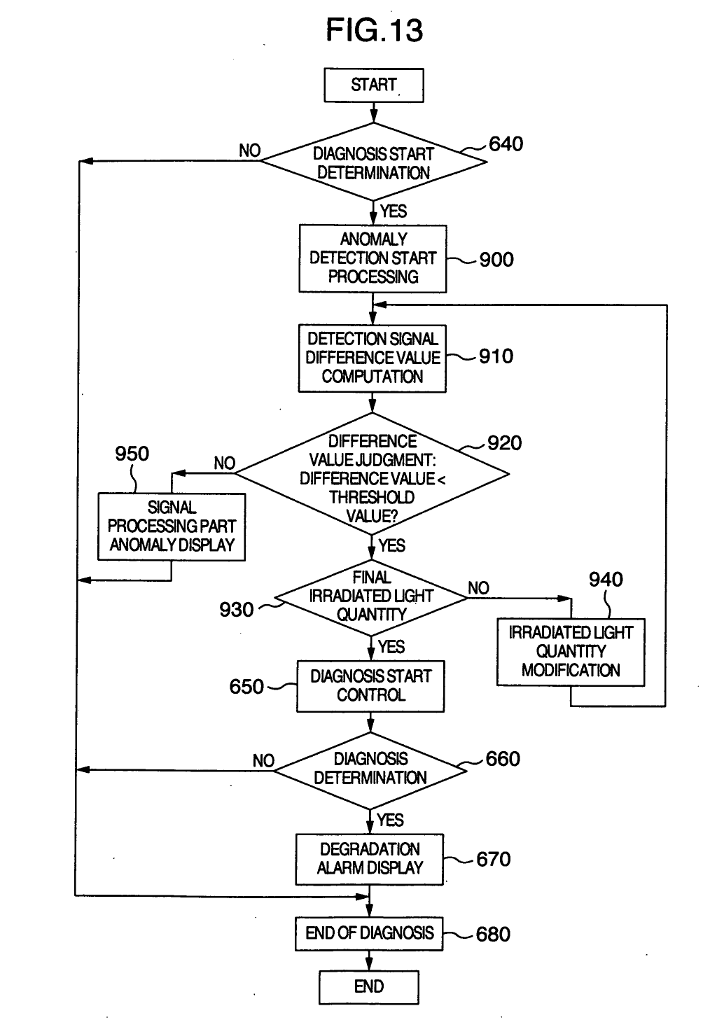

Next, an explanation will be given of Embodiment 3 of the present invention, with reference to FIG. 12 and FIG. 13.

The point which differs between this Embodiment 3 and Embodiment 1 is the point that it has become possible to detect anomalies of a detection signal processing part 461 by the fact that a detection signal processing part 462 has been added and that anomaly detection processing steps 900, 910, 920, 930, 940, and 950 shown in FIG. 13 have been added between steps 640 and 650 shown in FIG. 7. Detection signal processing part 462 is a reference arranged for detecting anomalies of detection signal processing part 461 and can carry out the same processing as detection signal processing part 461. Since other configurations are the same as those of Embodiment 1, a detailed explanation thereof will be omitted.

In Embodiment 3 of the present invention, the irradiation light quantity of laser beam 458 is modified and a signal 461s processed in detection signal processing part 461 (first signal processing unit) from the detection signals of detectors 460a and 460b at this time and a signal 462s processed in detection signal processing part 462 (second signal processing unit) are judged in data processing part 500, so it is possible to detect anomalies of detection signal processing part 461.

FIG. 13 is an operational flowchart during the photomultiplier tube diagnosis associated with Embodiment 3.

In FIG. 13, in processing step 640 of determining the start of the photomultiplier tube diagnosis, the process advances to the added processing step 900 of starting anomaly detection if it is determined that it is the start of the diagnosis, and the irradiation light quantity is set to that for the start of the anomaly detection. Next, the process advances to processing step 910 of computing the difference value of the detection signals and the difference value between signal 461s and signal 462s is computed. Further, it is acceptable for the difference value computation to record a signal in advance as a reference in data processing part 500 and obtain the difference with respect to signal 461s.

Next, the process advances to processing step 920 of determining the difference value and in case the difference value computed in step 910 is less than a threshold value, the process branches to processing step 930 of determining the final irradiation light quantity. In step 920, in case the difference value is equal to or greater than the threshold value, the process branches to processing step 950 of displaying a signal processing part anomaly.

In processing step 930 of determining the final irradiation light quantity, it is judged whether the irradiated light quantity is final or not and in case it is not the final irradiated light quantity, the process branches to processing step 940 of modifying the irradiated light quantity. In step 930, in case the irradiated light quantity is final, the process branches to processing step 650 of controlling the start of the photomultiplier tube diagnosis.

In processing step 940 of modifying the irradiated light quantity, the irradiated light quantity is changed to the following irradiated light quantity and the process returns to step 910.

In processing step 950 of displaying a signal processing part anomaly, the result of the signal process part anomaly detection is output to display device 530 and an alarm is given on the anomaly of the signal processing part. And then, the process advances to step 680.

As mentioned above, according to Embodiment 3 of the present invention, in addition to the possibility of obtaining the same effect as with Embodiment 1, in case signal detection processing part 461 has an anomaly, the same is detected and an alarm can be given. Further, in the present embodiment, an anomaly of detection signal processing part 461 is detected in both detectors 460a and 460b, but the invention is not limited hereto, it being acceptable to use a single detection signal processing unit, or a plurality of units exceeding two, making it possible to improve the anomaly detection system.

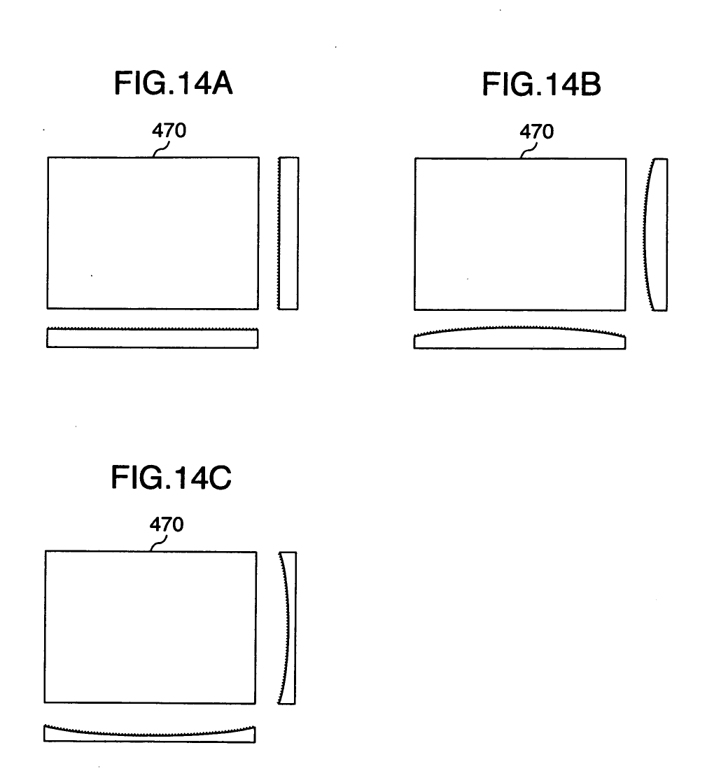

Here, as mentioned above, it is desirable for reflective plate 470 used in the present invention to have a surface shape emitting scattered light uniformly, but, as shown in FIG. 14A, FIG. 14B, and FIG. 14C, the surface may be any one of a planar shape, a convex shape, or a concave shape.

Also, in the aforementioned Embodiments 1 to 3, photomultiplier tubes are used for the scattered light detectors, but the invention is not limited hereto, it being possible, if what is concerned is a detector converting the analysis light emitted from the object under inspection and the reflected light into electrical signals, to suppress the influence of the variations in characteristics of the same detector. E.g., even in an inspection apparatus using an APD (Avalanche Photodiode) for the detector, it is possible to obtain the same effect.

Moreover, an inspection apparatus for contaminants of a semiconductor substrate related to the manufacturing of semiconductor devices has been explained taking a wafer as an example of an object under inspection, but the present invention is not limited to a semiconductor substrate, application thereof being possible if what is concerned is an inspection apparatus and an inspection method for a planar substrate, no matter whether it is a glass substrate used in flat panel display devices, an AlTiC (aluminum titanium carbide) substrate, a sapphire substrate used in sensors, LEDs (Light Emitting Diodes), and the like, or a disk substrate.

In addition, the invention is not one limited to semiconductor devices, application thereof being possible to various manufacturing processes such as for hard disks, flat panel display devices, and mask sensors.

1. A surface inspection apparatus for an object under inspection, comprising:
a holding unit holding the object under inspection;
a light irradiation unit irradiating illumination light on the surface of the object under inspection held by said holding unit;
one or several scattered light detection units detecting scattered light generated from said object under inspection by means of the irradiated light irradiated on said object under inspection from said light irradiation unit;
a surface inspection unit determining contaminants and the like on the surface of said object under inspection on the basis of scattered light detected by said scattered light detection unit;
a reflective plate reflecting illumination light from said light irradiation unit; and
an operating control unit causing illumination light from said light irradiation unit to be irradiated on said reflective plate during idling, at times other than during surface inspection of the object under inspection, and causing scattered light from said reflective plate to be irradiated on said scattered light detection unit.

2. The surface inspection apparatus according to claim 1, wherein:
said reflective plate is fastened to said holding unit; and said operating control unit moves said holding unit, causes illumination light from said light irradiation unit to be irradiated on the object under inspection during surface inspection of the object under inspection, and causes illumination light from said light irradiation unit to be irradiated on said reflective plate during said idling.

3. The surface inspection apparatus according to claim 1, wherein said operating control unit moves said light irradiation unit, causes illumination light from said light irradiation unit to be irradiated on the object under inspection during surface inspection of the object under inspection, and causes illumination light from said light irradiation unit to be irradiated on said reflective plate during said idling.

4. The surface inspection apparatus according to claim 1, having a degradation alarm unit, wherein:
said operating control unit stores a detected signal scattered from said reflective plate and detected in and output from said scattered light detection unit during said idling;
when said idling has come to an end and before the start of the surface inspection of the object under inspection, judges the presence of degradation of said scattered light detection unit on the basis of said stored detection signal of said scattered light detection unit; and,
in case there is degradation, causes an alarm to be given by said degradation alarm unit.

5. The surface inspection apparatus according to claim 1, wherein said operating control unit has a data processing part judging, on the basis of the detection signal of said scattered light detection unit, the presence of degradation of said scattered light detection unit, and a plurality of signal processing units performing signal processing of the output signals from said scattered light detection unit into signals that can be processed by said data processing unit; and
said data processing unit computes the mutual differences of the output signals from said plurality of signal processing units and judges, on the basis of the computed differences, whether an anomaly has occurred in any of said plurality of signal processing units.

6. The surface inspection apparatus according to claim 1, wherein said object under inspection is a semiconductor wafer and said scattered light detection unit is a photomultiplier tube.

7. The surface inspection apparatus according to claim 1, wherein said reflective plate is a diffuser plate.

8. The surface inspection apparatus according to claim 7, wherein said reflective plate is formed of any of glass, ceramic, or a semiconductor.

9. A surface inspection method for an object under inspection, irradiating illumination light on the surface of an object under inspection held by a holding unit;
detecting by a scattered light detection unit the illumination light irradiated on and scattered by said object under inspection; and
determining contaminants and the like on the surface of said object under inspection on the basis of the scattered light detected by said scattered light detection unit; wherein,
during idling, at times other than during surface inspection of the object under inspection, said illumination light is caused to be irradiated on a reflective plate and the illumination light scattered by said reflective plate is caused to be irradiated on said scattered light detection unit.

10. The surface inspection method according to claim 9, storing the detected signal scattered from said reflective plate and detected in and output from said scattered light detection unit during said idling;
judging, when said idling has come to an end and before the start of the surface inspection of the object under inspection, the presence of degradation of said scattered light detection unit, on the basis of said stored detection signal of said scattered light detection unit; and
giving an alarm in case there is degradation.

11. A surface inspection apparatus for an object under inspection having:
a holding unit holding the object under inspection;
a light irradiation unit irradiating illumination light on the surface of the object under inspection held by said holding unit;
a scattered light detection unit detecting scattered light generated from said object under inspection by means of the irradiated light irradiated on said object under inspection from said light irradiation unit;
a surface inspection unit determining contaminants and the like on the surface of said object under inspection on the basis of scattered light detected by said scattered light detection unit; and a degradation alarm unit in the surface inspection apparatus according to claim 1.

12. The surface inspection apparatus according to claim 11, wherein said degradation alarm unit has a display unit displaying whether or not there is degradation in said scattered light detection unit.

13. The surface inspection apparatus according to claim 11, wherein said degradation alarm unit gives an alarm about the degradation of said scattered light detection unit.
